(19) United States
(12) Patent Application Publication
(10) Pub. No.: US 2026/0266703 A1
(43) Pub. Date: Sep. 10, 2026

(54) DEVICE FOR CONCENTRATING BIOMARKER IN SAMPLE USING OSMOTIC PRESSURE

(71) Applicant: INSOL Co., Ltd., Hanam-si (KR)

(72) Inventors: Eun-Soo JEONG, Seoul (KR); Jae-Hyun AHN, Hanam-si (KR); Ji-Ae SONG, Gwangju-si (KR)

(21) Appl. No.: 19/551,877

(22) Filed: Feb. 27, 2026

(30) Foreign Application Priority Data
Feb. 27, 2025 (KR) 10-2025-0026176
Jan. 27, 2026 (KR) 10-2026-0015833

(51) Int. Cl. G01N 1/40

(52) U.S. Cl. CPC G01N 1/4077

(57) ABSTRACT

A sample concentration device and method according to the present disclosure may concentrate a large amount of a sample in a simple manner within a short time and increase the target concentration in the sample, thereby increasing the sensitivity of an in vitro diagnostic kit. In addition, the sample concentration device and method may be conveniently used on site without a separate additional device or facility such as a centrifuge, and thus may provide a simple and effective means for increasing diagnostic sensitivity when testing using an in vitro diagnostic kit at a hospital site or the like.

### BACKGROUND

### 1. Technical Field

The present disclosure relates to a sample concentration device and method for application to in vitro diagnostic medical devices, etc., and more specifically, to a sample concentration device and method for conveniently concentrating a sample containing a biomarker on site.

### 2. Related Art

In vitro diagnosis is a technology that diagnoses, predicts, or monitors disease by detecting a biomarker (e.g., infectious agent or reaction product) in a biological sample such as tissue, blood, saliva, urine, a cell washing solution, or the like. The recent COVID-19 pandemic has led to a rapid increase in the use of in vitro diagnostic medical devices, and in particular, rapid diagnostic kits using lateral flow assay (LFA) have been widely available and used by the general public.

The LFA rapid diagnostic kits are faster than molecular diagnostic methods, such as PCR (Polymerase Chain Reaction), and do not require a separate device or power supply for testing, making them widely used in small hospitals or even for individual users. However, the LFA rapid diagnostic kits have the disadvantage of lower sensitivity compared to molecular diagnostic methods, and thus are extremely limited in their use for confirmatory testing.

To overcome the disadvantage of these LFA rapid diagnostic kits, methods using centrifugation (Korean Patent Application Publication No. 10-2022-0115462), magnetic nanoparticles (Korean Patent Application Publication No. 10-2015-0112519), or filter filtration (Korean Patent Application Publication No. 10-2023-0013613) have been devised.

In addition, in a pandemic situation of a specific infectious disease such as COVID-19, medical institutions mainly use highly sensitive PCR tests for confirmation due to the low sensitivity of the LFA kits, but the proportion of use of pooling tests that mix and test multiple samples is also quite high. These pooling tests have the advantage of being able to efficiently process a large number of samples within a short period of time at a low testing cost, but they also have a disadvantage in that sensitivity may be decreased due to the dilution of positive samples by negative samples during sample pooling. Currently, there is no on-site testing method capable of overcoming this disadvantage.

As described above, conventional techniques for concentrating and recovering biomarkers such as viruses from samples have limitations in that they require a multi-step process and a separate device, and require the skill of the experimenter, so that they are only used at the laboratory level and are not commonly used as hospital kits or commercial products.

Accordingly, the inventors of the present disclosure have conducted studies on a method capable of easily concentrating a biological sample on site and applying it to an LFA rapid diagnostic kit or a molecular diagnostic kit, thereby completing the present disclosure.

### PRIOR ART DOCUMENTS

### Patent Documents

Korean Patent Application Publication No. 10-2022-0115462

Korean Patent Application Publication No. 10-2015-0112519

Korean Patent Application Publication No. 10-2023-0013613

### SUMMARY

The present disclosure has been made in order to solve the above-described problems, and is intended to provide a sample concentration device and method that can significantly improve sensitivity when applied to an in vitro diagnostic kit by effectively concentrating a biomarker such as virus or bacteria in a sample by osmotic pressure.

The present disclosure is intended to provide a sample concentration device and method capable of effectively concentrating a sample without a separate additional device or facility requiring an external power source, such as a centrifuge.

However, the technical problems to be solved by the present disclosure are not limited to the problems mentioned above, and other problems not mentioned can be clearly understood by those skilled in the art to which the present disclosure pertains from the following description.

The present disclosure provides a sample concentration device including a sample chamber and an osmotic pressure-inducing fluid chamber, wherein the osmotic pressure-inducing fluid chamber includes a column portion and a pressure control portion, wherein the column portion is inserted into the sample chamber, and the column portion includes a membrane support and a membrane, wherein the membrane is positioned between the membrane support and the sample chamber.

The membrane may be in contact with the outer surface of the membrane support and may not be in contact with the sample chamber.

The membrane may be a semi-permeable membrane.

The pressure control portion may include a sealing stopper and be coupled to the upper portion of the column portion.

The pressure control portion may include a hollow portion therein and be open at the bottom.

The pressure control portion may be configured to apply a positive pressure of 101% to 150% to the osmotic pressure-inducing fluid chamber when coupled to the upper portion of the column portion.

The osmotic pressure-inducing fluid chamber may be configured such that an osmotic pressure-inducing solution is introduced into the column portion, wherein the osmotic pressure-inducing solution may include one or two or more selected from the group consisting of polyethylene glycol, dextran, polyvinylpyrrolidone, hydroxyethylcellulose, and carboxymethyl cellulose.

The sample chamber may include a sample inlet, a sample moving portion, and a sample discharge portion.

The present disclosure provides a sample concentration method for concentrating a sample using the sample concentration device.

The sample concentration method includes steps of: introducing an osmotic pressure-inducing solution into a column portion of an osmotic pressure-inducing fluid chamber; introducing a sample into a sample inlet of a sample chamber; coupling a pressure control portion to the upper portion of the column portion of the osmotic pressure-inducing fluid chamber; allowing the introduced sample to be concentrated while passing through a sample moving portion; separating the osmotic pressure-inducing fluid chamber after the concentrated sample is collected at the bottom of the sample chamber; and allowing the concentrated sample collected at the bottom of the sample chamber to move to a sample discharge portion.

The sample concentration device and method of the present disclosure may concentrate a large amount of a sample and increase the target concentration in the sample, thereby increasing the sensitivity of an in vitro diagnostic kit.

In addition, the sample concentration device and method according to the present disclosure may be conveniently used on site without a separate additional device or facility such as a centrifuge, and thus can provide a simple and effective means for increasing diagnostic sensitivity when testing using an in vitro diagnostic kit at a testing site or laboratory.

The effects that may be obtained from the present disclosure are not limited to the effects mentioned above, and other effects that are not mentioned may be clearly understood by those skilled in the art to which the present disclosure pertains from the following description.

### BRIEF DESCRIPTION OF THE DRAWINGS

FIG. 1 schematically illustrates a sample concentration device according to one embodiment of the present disclosure.

FIG. 2 is an exploded perspective view of a sample chamber in the sample concentration device according to one embodiment of the present disclosure.

FIG. 3 is an exploded perspective view of an osmotic pressure-inducing fluid chamber in the sample concentration device according to one embodiment of the present disclosure.

FIG. 4 is a longitudinal sectional view illustrating the configuration of the column portion of the osmotic pressure-inducing fluid chamber in the sample concentration device according to one embodiment of the present disclosure.

FIGS. 5A to 5C illustrate a pressure control portion 210 according to one embodiment of the present disclosure.

FIG. 6 is a drawing illustrating a method of introducing an osmotic pressure-inducing solution into the sample concentration device according to one embodiment of the present disclosure.

FIG. 7 is a diagram schematically illustrating a process in which a sample introduced into the sample concentration device according to one embodiment of the present disclosure is concentrated and discharged.

FIG. 8 illustrates the steps from sample introduction to sample concentration and concentrated sample collection using the sample concentration device according to one embodiment of the present disclosure.

FIG. 9 is a photograph showing the amount of concentrated liquid recovered after concentrating a sample depending on whether or not an osmotic pressure-inducing fluid chamber in the sample concentration device according to one embodiment of the present disclosure has a stopper.

FIG. 10 is a graph showing the amount of concentrated liquid recovered after concentrating a sample depending on whether or not the osmotic pressure-inducing fluid chamber in the sample concentration device according to one embodiment of the present disclosure has a stopper.

FIG. 11 shows results indicating that the sensitivity of a sample concentrated using the sample concentration device according to one embodiment of the present disclosure was improved.

FIG. 12 shows the results of performing a PCR experiment on an inactivated COVID-19 virus sample before and after concentration using the sample concentration device according to one embodiment of the present disclosure.

### DETAILED DESCRIPTION

The sample concentration device and method according to the present disclosure are for concentrating a biomarker (protein, bacteria, virus, etc.) in a sample, and the present disclosure relate to a sample concentration device and method that can significantly improve sensitivity by effectively concentrating a biomarker in a sample by osmotic pressure and can effectively concentrate the biomarker without an additional device.

Hereinafter, embodiments of the present disclosure will be described in more detail with reference to the drawings. However, the following drawings attached to the present specification illustrate preferred embodiments of the present disclosure and, together with the contents of the disclosure described above, serve to further understand the technical concept of the present disclosure. Therefore, the present disclosure should not be interpreted as being limited only to matters described in such drawings.

As used herein, the terms “includes”, “comprises”, “including” and/or “comprising” do not preclude the presence or addition of one or more other components, steps, operations, and/or elements other than stated components, steps, operations, and/or elements. Like reference numerals refer to like components throughout the specification.

### Sample Concentration Device

The present disclosure relates to a sample concentration device including a sample chamber 100 and an osmotic pressure-inducing fluid chamber 200, wherein the osmotic pressure-inducing fluid chamber 200 includes a column portion 220 and a pressure control portion 210, wherein the column portion 220 is inserted into the sample chamber 100, and the column portion 220 includes a membrane support 221 and a membrane 222, wherein the membrane 222 is positioned between the membrane support 221 and the sample chamber 100.

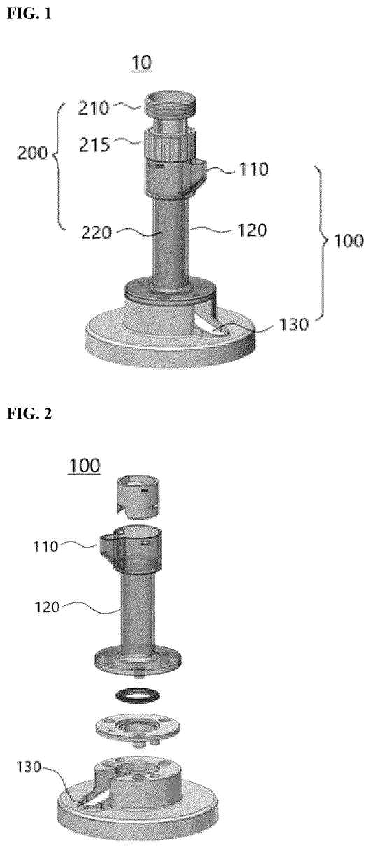

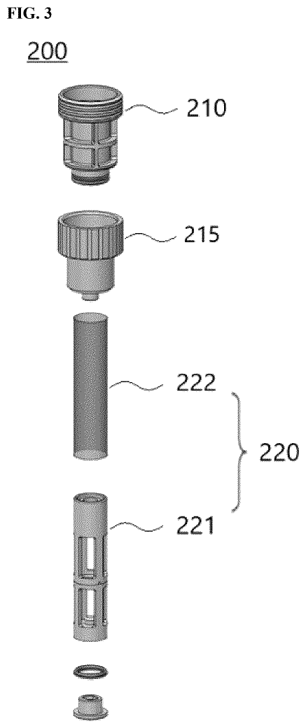

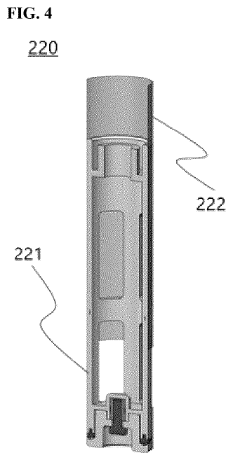

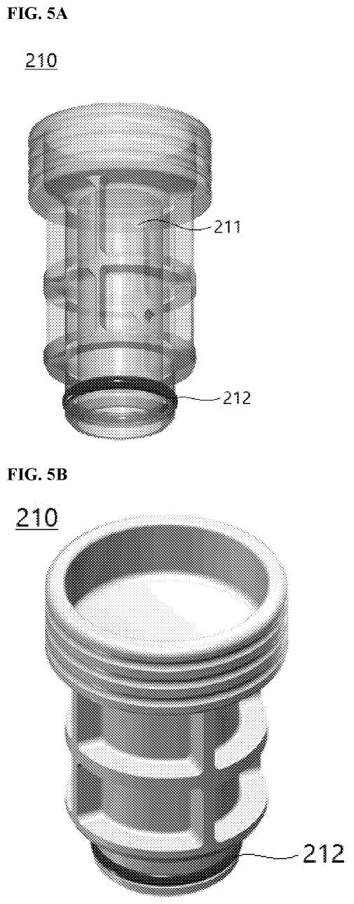

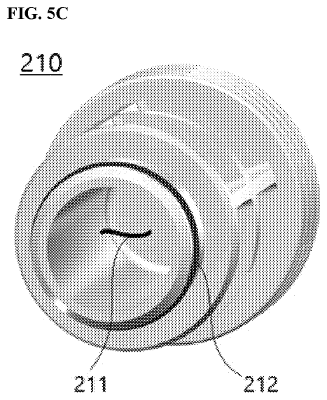

FIG. 1 schematically illustrates a sample concentration device according to one embodiment of the present disclosure, FIG. 2 is an exploded perspective view of a sample chamber in the sample concentration device according to one embodiment of the present disclosure, FIG. 3 is an exploded perspective view of an osmotic pressure-inducing fluid chamber in the sample concentration device according to one embodiment of the present disclosure, and FIG. 4 is a longitudinal sectional view illustrating the configuration of the column portion of the osmotic pressure-inducing fluid chamber in the sample concentration device according to one embodiment of the present disclosure. FIGS. 5A to 5C illustrate a pressure control portion 210 according to one embodiment of the present disclosure, and specifically, FIG. 5A shows a hollow portion 211 inside the pressure control portion, FIG. 5B is a drawing viewed from above, and FIG. 5C is a drawing viewed from below.

Referring to FIGS. 1 to 5C, a sample concentration device according to one embodiment of the present disclosure includes a sample chamber 100 and an osmotic pressure-inducing fluid chamber 200.

The sample chamber 100 includes a sample inlet 110, a sample moving portion 120, and a sample discharge portion 130.

The sample inlet 110 may be provided on the upper outer side of the sample chamber 100, and a sample may be easily introduced into the sample inlet 110.

The introduced sample moves through the sample moving portion 120, and the sample is concentrated by a column portion 220 of the osmotic pressure-inducing fluid chamber 200 located inside the sample moving portion 120 and may be moved to the bottom of the sample chamber 100.

The concentrated sample is collected at the bottom of the sample chamber 100, and by separating the osmotic pressure-inducing fluid chamber 200, the sample may flow out to the sample discharge portion 130 and the concentrated sample may be easily recovered.

Meanwhile, the sample in the present disclosure may mean a sample collected from a subject to be examined, and may mean tissue, cells, blood, body fluid, urine, etc. collected or taken from a human or animal, and serum, plasma, chromosomes, DNA, RNA, proteins, etc. isolated therefrom. It is preferable that the sample be in a liquid state or in a state in which it is uniformly dispersed or dissolved in a liquid.

The osmotic pressure-inducing fluid chamber 200 includes a column portion 220 and a pressure control portion 210, wherein the column portion 220 is inserted into the sample chamber 100.

The column portion 220 includes a membrane support 221 and a membrane 222, wherein the membrane 222 serves to induce an osmotic effect and is characterized by being positioned between the membrane support 221 and the sample chamber 100.

Specifically, the membrane 222 is positioned in contact with the outer surface of the membrane support 221 and does not contact the sample moving portion 120 of the sample chamber 100, so that a space through which the introduced sample may move may be secured between the membrane 222 and the sample moving portion 120 of the sample chamber 100.

The membrane 222 may be, for example, a semi-permeable membrane.

A semi-permeable membrane is a type of biological membrane or synthetic polymer membrane that allows specific molecules or ions to pass by osmosis. The rate of permeation varies depending not only on the membrane's permeability to each solute but also on the pressure, concentration, and temperature of the molecules or solutes located on both sides of the semi-permeable membrane.

In the present disclosure, the membrane 222 may include a semi-permeable membrane. The semi-permeable membrane includes any semi-permeable membrane capable of performing the function of allowing a solvent component to pass by an osmotic pressure gradient and allowing the component to be analyzed to remain in an concentrated region. As long as such a function may be implemented, there is no particular limitation on the material, thickness, pore size, or manufacturing method of the semi-permeable membrane.

The membrane 222 is positioned between the membrane support 221 of the osmotic pressure-inducing fluid chamber 200 and the sample moving portion 120 of the sample chamber 100, and thus may have a shape that may maximize the specific surface area of the portion that comes into contact with the membrane 222 as a liquid sample passes therethrough.

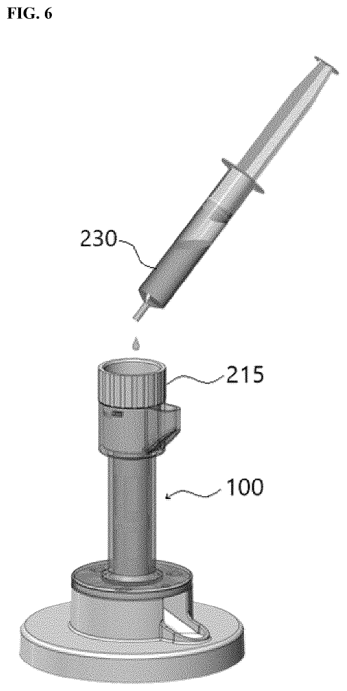

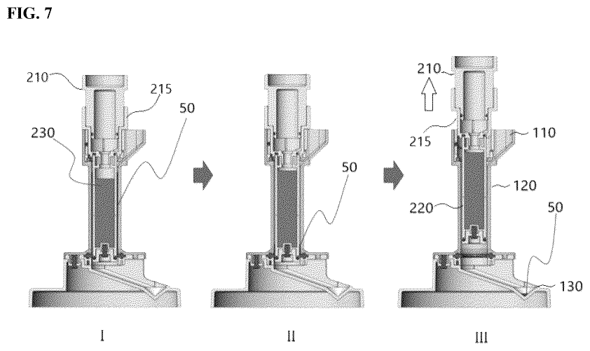

Referring to FIG. 6, an osmotic pressure-inducing solution 230 is introduced into the column portion 220, and the osmotic pressure-inducing solution 230 is positioned on the inner surface of the membrane 222, i.e., the semi-permeable membrane. Then, a sample 50 introduced into the sample inlet 110 is positioned in contact with the outer surface of the membrane 222, so that osmotic pressure may be induced and the sample may be concentrated.

The osmotic pressure-inducing solution 230 is a draw solution that is used in a forward osmosis process, and plays a role in inducing osmotic pressure so that water molecules move into the osmotic pressure-inducing fluid chamber 200 through the semi-permeable membrane. The osmotic pressure-inducing solution may include one or two or more selected from the group consisting of polyethylene glycol, dextran, polyvinylpyrrolidone, hydroxyethylcellulose, and carboxymethyl cellulose. It is preferable to use a polymer-based osmotic pressure-inducing solution in terms of suppressing the reverse diffusion of solutes through the semi-permeable membrane and maintaining the purity of the sample.

In addition, the osmotic pressure-inducing solution 230 may be filled to 50% to 100% of the height of the column portion 220, taking into consideration the driving force by the osmotic pressure gradient across the semi-permeable membrane and the amount of the sample being introduced, without being limited thereto.

The osmotic pressure-inducing fluid chamber 200 includes a pressure control portion 210 on the column portion 220.

The pressure control portion 210 may include a sealing stopper. As the pressure control portion 210 is coupled to the upper portion of the column portion 220, it may provide isolation from the outside. When the pressure control portion 210, i.e., the sealing stopper, and the column portion 220 are coupled to each other, a fastening portion 215 may be further used to facilitate the coupling.

That is, the fastening portion 215 may help the pressure control portion 210 to be fixed after being coupled to the column portion 220 and inserted into the sample chamber 100.

The pressure control portion 210 may be coupled to the column portion 220 through the fastening portion 215 after the osmotic pressure-inducing fluid solution 230 and the sample 50 are introduced, whereby the inside of the osmotic pressure-inducing fluid chamber 200 may be completely sealed off from the outside.

The pressure control portion 210 may be sealed by being coupled to the fastening portion 215 fastened to the upper portion of the sample chamber 100, and at this time, the air existing in the internal space of the fastening portion 215 is pushed into the column portion 220 to pressurize it.

In order for the pressure control portion 210 and the fastening portion 215 to be well coupled to each other, the fastening portion 215 may have a groove or a projection therein, and the pressure control portion 210 may include a projection, groove, or stepped portion that corresponds thereto. As long as the coupling and fastening may be well achieved as described above, the fastening means is not particularly limited. In addition, the pressure control portion 210 may be provided with an O-ring 212 so that it may be sealed together with coupling to the fastening portion 215.

As such, the osmotic pressure-inducing solution 230 filled inside the column portion 220 may be slightly expanded toward the membrane support 221 by the positive pressure sealed through the pressure control portion 210, thereby increasing the surface area where the osmotic pressure-inducing solution comes into contact with the membrane 222 attached to the outside of the membrane support 221. In addition, a semi-permeable membrane having any thickness may be quickly wetted by the solution. Thereby, the membrane 222, a semi-permeable membrane, may come into contact with the osmotic pressure-inducing solution more quickly and over a larger surface area even when positioned outside the membrane support 221, and the surface area where the osmotic pressure-inducing solution 230 and the liquid sample 50 come into contact with each other through the semi-permeable membrane increases, thereby increasing the amount of movement of the liquid sample 50 by osmotic pressure, thus enabling sample concentration to proceed more quickly.

Meanwhile, when the liquid sample 50 flows in contact with the membrane 222, a solid-liquid bilayer may be formed. The pressure control portion 210 is coupled to the fastening portion 215 while applying force during coupling. As such, the solid-liquid bilayer may be minimized through the micro-pressure added during sealing, i.e., positive pressure, and the impact generated during fastening by the protrusions and grooves formed in the sealing stopper and the fastening portion, thereby reducing resistance, thus allowing the liquid sample to more easily come into contact with the semi-permeable membrane.

In particular, the pressure control portion 210 may be in the form of a sealing stopper having a structure in which the top is closed as shown in FIG. 5B, but the bottom is open as shown in FIG. 5C, and a hollow portion 211 is included therein as shown in FIGS. 5A and 5C.

By including the hollow portion 211 inside the stopper as described above, the pressure applied to the osmotic pressure-inducing solution 230 may be appropriately lowered so as not to be excessive. If excessive pressure is applied to the osmotic pressure-inducing solution 230, the membrane 222 may expand excessively, resulting in a reverse osmosis phenomenon in which the osmotic pressure-inducing solution seeps out of the semipermeable membrane.

The hollow portion 211 is not particularly limited as long as it has a hollow shape, and may have a hollow cylindrical shape, for example.

The depth and size of the hollow portion may be adjusted so that an appropriate pressure may be applied to the osmotic pressure-inducing solution 230.

When the pressure control portion 210 is coupled to the fastening portion 215, the shape of the O-ring 212 is temporarily compressed, thereby momentarily reducing the internal volume of the osmotic pressure-inducing fluid chamber 200 by 1% to 30% during the insertion process. At this time, the momentarily increased pressure may be increased by 1% to 43% with respect to the pressure of the column portion 220 exposed before the pressure control portion 210 is coupled to the fastening portion 215. As such, the pressure control portion is provided in the form of a sealing stopper including a hollow space therein, and is coupled to the upper portion of the column portion. When the pressure of the osmotic pressure-inducing fluid chamber before the pressure control portion and the upper portion of the column portion are coupled to each other is set to 100%, the pressure control portion allows a positive pressure of 101% to 150% to be applied to the osmotic pressure-inducing fluid chamber. As the pressure within the above range is applied, the efficiency of water movement by osmotic pressure may be maintained without reverse leakage of the osmotic pressure-inducing fluid into the sample while maintaining the structural stability of the semi-permeable membrane.

If the pressure control portion 210 does not include the hollow portion 211 therein, when the pressure control portion is coupled, the pressure may increase excessively to more than 50% of the atmospheric pressure, which may interfere with the forward osmosis process or cause reverse osmosis.

Thereby, the sample concentration device of the present disclosure may significantly increase the concentration rate of the sample, and may significantly increase the concentration speed while improving the sensitivity of the concentrated sample.

Therefore, using the sample concentration device of the present disclosure, the target concentration in the sample may be increased without a separate additional device or facility such as a centrifuge, thereby effectively improving the diagnostic sensitivity.

Thereafter, when the osmotic pressure-inducing fluid chamber 200 is separated, the concentrated sample 50 remaining in the chamber automatically moves to the bottom of the sample chamber 100, and the concentrated sample 50 collected at the bottom of the sample chamber flows to and is collected in the sample discharge portion 130.

For the separation of the osmotic pressure-inducing fluid chamber 200, the pressure control portion 210 and the fastening part 215 may be separated from the sample chamber 100, so that the osmotic pressure-inducing fluid chamber 200 including the column portion 220 may be separated from the sample chamber 100.

The concentrated sample 50 collected in the sample discharge portion 130 as described above may be easily recovered.

### Sample Concentration Method

The present disclosure relates to a sample concentration method for concentrating a sample using the sample concentration device described above, and includes, without limitation, the contents described in the “Sample Concentration Device” section described above.

The sample concentration method of the present disclosure includes steps of: introducing an osmotic pressure-inducing solution 230 into a column portion 220 of an osmotic pressure-inducing fluid chamber 200; introducing a sample 50 into a sample inlet 110 of a sample chamber 100; coupling a pressure control portion 210 to the upper portion of the column portion 220 of the osmotic pressure-inducing fluid chamber 200; allowing the introduced sample 50 to be concentrated while passing through a sample moving portion 120; separating the osmotic pressure-inducing fluid chamber 200 after the concentrated sample 50 is collected at the bottom of the sample chamber 100; and allowing the concentrated sample 50 collected at the bottom of the sample chamber 100 to move to a sample discharge portion 130.

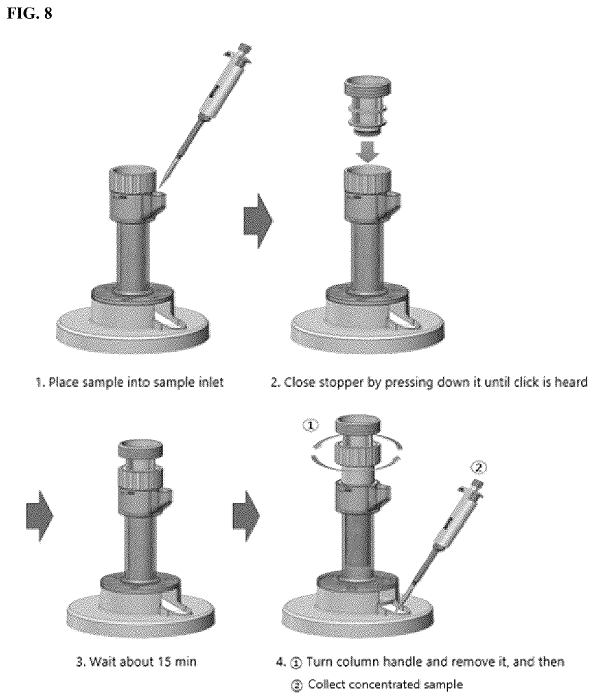

FIG. 6 is a drawing illustrating a method of introducing an osmotic pressure-inducing solution into the sample concentration device according to one embodiment of the present disclosure, FIG. 7 is a diagram schematically illustrating a process in which a sample introduced into the sample concentration device according to one embodiment of the present disclosure is concentrated and discharged, and FIG. 8 illustrates the steps from sample introduction to sample concentration and concentrated sample collection using the sample concentration device according to one embodiment of the present disclosure.

The sample concentration method of the present disclosure is for concentrating a sample using the sample concentration device of the present disclosure. As illustrated in FIG. 6, first, an osmotic pressure-inducing solution 230 is introduced into the column portion 220 of the osmotic pressure-inducing fluid chamber 200.

The osmotic pressure-inducing solution 230 may be filled to 50% to 100% of the height of the column portion 220 in consideration of the driving force by the osmotic pressure gradient across the semi-permeable membrane and the amount of the sample to be introduced, without being limited thereto.

At this time, the column portion 220 may first be fastened to the sample chamber 100 through the fastening portion 215, and then the osmotic pressure-inducing solution 230 may be introduced.

After the inside of the column portion 220 is filled with the osmotic pressure-inducing solution 230, as shown in FIG. 8, a sample 50 is introduced into the sample inlet 110 of the sample chamber 100.

Next, the concentration of the sample is performed by coupling the pressure control portion 210 to the upper portion of the column portion 220.

The pressure control portion 210 may be in the form of a sealing stopper, through which the inside of the osmotic pressure-inducing fluid chamber 200 may be sealed. The coupling of the pressure control portion 210 to the column portion 220 may be facilitated through the fastening portion 215.

At this time, when the liquid sample 50 flows outside the membrane 222 while pressure and impact are applied through pressurization at the time of coupling of the pressure control portion 210, the solid-liquid bilayer may be minimized, and the semi-permeable membrane attached to the membrane support 221 expands in the direction of the introduced liquid sample 50, thereby increasing the surface area where the osmotic pressure-inducing solution 230 and the liquid sample come into contact with each other through the semi-permeable membrane, so that the osmotic pressure-inducing solution 230 inside the membrane 222 may better permeate into the membrane 222, thereby accelerating the osmotic pressure effect.

By coupling the pressure control portion 210 as described above, the inside of the sample concentration device may be completely sealed off from the outside, and the concentration speed of the sample may be significantly increased by maximizing the osmotic pressure effect overall, so that a high concentration rate may be achieved within a short period of time and the diagnostic sensitivity during diagnosis may be significantly increased.

Referring to FIGS. 7 and 8, the introduced sample 50 flows into the space between the membrane 222 of the column portion 220 of the osmotic pressure-inducing fluid chamber 200 and the sample moving portion 120 of the sample chamber 100, as described above, and is concentrated while coming into contact with the membrane 222, i.e., the semi-permeable membrane, and the concentrated sample 50 is collected at the bottom of the sample chamber 100.

The operating time may be adjusted so that the introduced sample 50 may be concentrated and collected at the bottom of the sample chamber depending on the amount or type of sample to be concentrated, the size of the sample concentration device 10, and whether single measurement or continuous measurement is performed, but the operating time is not particularly limited. According to one embodiment of the present disclosure, the operating time may be set at 1 second to 30 minutes, preferably 10 to 20 minutes.

Thereafter, by separating the fastening portion 215 of the osmotic pressure-inducing fluid chamber 200 from the sample chamber 100, the osmotic pressure-inducing fluid chamber 200 coupled to the fastening portion 215 may be separated from the sample chamber 100. When separating the osmotic pressure-inducing fluid chamber 200 from the sample chamber 100, the fixing means of the fastening portion 215 at the upper portion of the column portion may be released, thereby separating the osmotic pressure-inducing fluid chamber 200 from the sample chamber 100 at once. For example, if the fastening portion 215 has been rotationally coupled to the upper portion of the sample chamber corresponding to the upper portion of the column portion, the fastening portion may be separated from the sample chamber by rotating it in the opposite direction, thereby separating the osmotic pressure-inducing fluid chamber 200 from the sample chamber 100.

As the osmotic pressure-inducing fluid chamber 200 is separated from the sample chamber 100 as described above, the concentrated sample 50 collected at the bottom of the sample chamber 100 is collected in the sample discharge portion 130, so that it may be easily recovered.

The sample concentration device and method of the present disclosure may concentrate a large amount of a sample without an additional device or facility, increase the target concentration in the sample, use an easily recoverable sample as a sample for diagnosis, and increase the sensitivity of an in vitro diagnostic kit, and thus they may provide a simple and effective means for increasing the diagnostic sensitivity when testing using an in vitro diagnostic kit at a testing site or laboratory.

The sample concentration device and method of the present disclosure may be applied without limitation to fields where concentration is applied, such as food and pharmaceuticals, in addition to the above-mentioned diagnosis.

Hereinafter, the present disclosure will be described in more detail through examples. However, the following examples are intended to illustrate the present disclosure, and the present disclosure is not limited to the following examples and may be variously modified and changed.

### Example and Comparative Example

### Example

Inactivated COVID-19 virus was added to PBS solution to prepare artificial samples at a concentration of 10⁻⁵ μg/ml to 10³ μg/ml, thus preparing 2 ml of each sample.

As illustrated in FIGS. 1 to 5C, the sample concentration device of the present disclosure was manufactured.

Specifically, the sample chamber 100 was manufactured using ABS material and had a length of 55 mm, an inner diameter of 17.7 mm, and an outer diameter of 22 mm.

The membrane support 221 was manufactured using ABS material by drilling holes in the outer wall of a cylinder with an outer diameter of 15.8 mm and an inner diameter of 12.8 mm so that the osmotic pressure-inducing solution 230 and the introduced sample 50 can come into contact with each other via the membrane. A total of 8 holes were drilled, and the width and height of each hole were 8 mm and 20 mm, respectively, based on the outer diameter.

A semipermeable membrane (SnakeSkin™ Dialysis Tubing, ThermoFisher Scientific, MWCO: 10 kDa) was prepared as the membrane 222 and wrapped around the outside of the membrane support 221, thereby preparing the column portion 220 which was then fixed inside the sample chamber. A 200% PEG-1000 aqueous solution was prepared as an osmotic pressure-inducing solution and filled to 80% of the height of the column portion.

Thereafter, the prepared sample was introduced into the sample inlet, and the pressure control portion 210 was fastened to the upper portion of the column portion 220 to block the column portion from the outside. At this time, the pressure control portion 210 was made of ABS material, and in order to induce an appropriate pressure change by reducing the pressure change compared to the depth at which the stopper is inserted, a sealing stopper having a hollow portion that is cylindrically hollow from the lower end of the stopper toward the inside of the stopper was prepared as the pressure control portion 210. The insertion depth of the stopper was designed so that the air volume at the upper portion of the osmotic pressure-inducing fluid is reduced by 15% after inserting the stopper in a state exposed to atmospheric pressure before inserting the stopper. Therefore, the pressure applied to the upper portion of the osmotic pressure-inducing fluid was increased by approximately 17% compared to before inserting the stopper.

After 15 to 20 minutes, the fastening portion 215 was detached from the sample chamber 100, thereby separating the osmotic pressure-inducing fluid chamber from the sample chamber 100 while moving it upward, and the concentrated sample collected in the sample discharge portion 130 was collected.

### Comparative Example

The sample was concentrated in the same manner as in the Example, except that the pressure control portion was not installed at the upper portion of the column portion.

### Experimental Examples

### Experimental Example 1

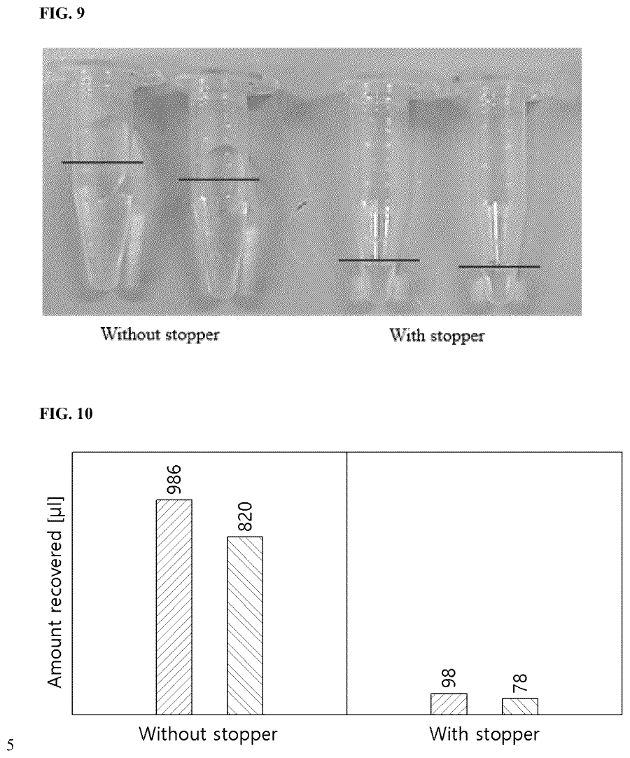

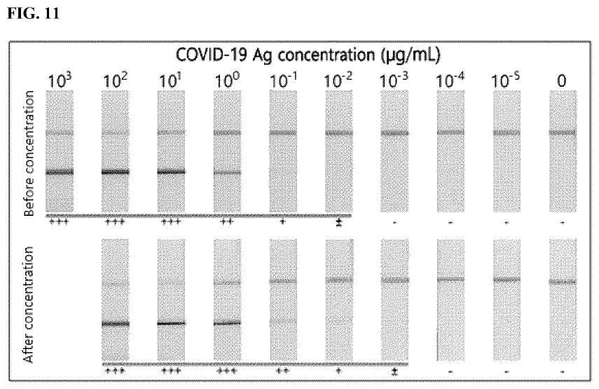

In the Example and the Comparative Example, when 2 ml of each artificial sample prepared by diluting a SARS-CoV-2 culture (1.2×10⁵ copies/μL, Heat Inactivated, ZeptoMatrix) at the ratio 1:512 in PBS buffer was concentrated for 20 minutes, the amount (volume) of each concentrated liquid recovered in the sample discharge portion 130 was measured using a micropipette, and the results are shown in FIGS. 9 and 10.

In FIGS. 9 and 10, the case without the stopper corresponds to the Comparative Example, and the case with the stopper corresponds to the Example.

As a result of the experiment, it can be confirmed that the sample of the Example, concentrated using the sample concentration device of the present disclosure, was recovered in a significantly reduced amount compared to the sample concentrated using the sample concentration device of the Comparative Example. Therefore, it can be seen that the concentration rate is significantly increased when the sample concentration device of the Example of the present disclosure is used.

### Experimental Example 2

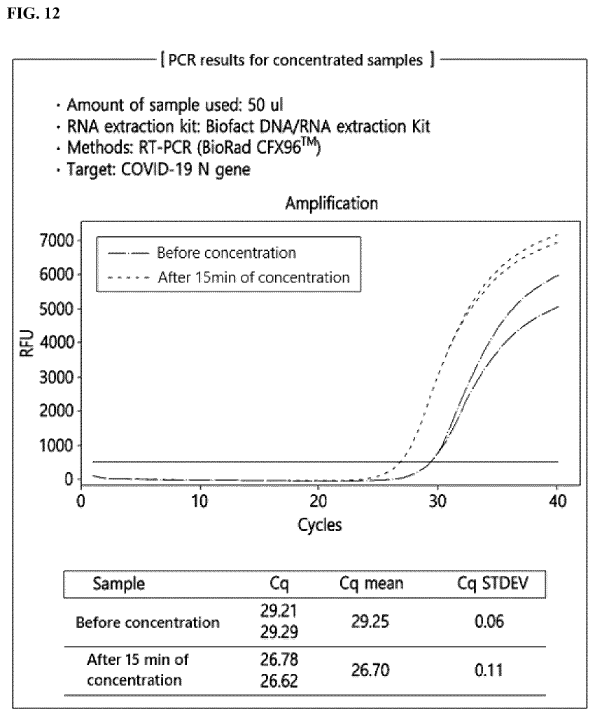

The undiluted SARS-CoV-2 culture (1.2×10⁵ copies/μL, Heat Inactivated, ZeptoMatrix) used in the Example and the sample obtained by concentrating and recovering the undiluted culture using the sample concentration device of the present disclosure were each diluted using PBS buffer by a 1:10 serial dilution method, thereby preparing samples. The samples serially diluted by 1:10 were compared by measuring detection using the INSOL COVID-19 Ag product, a COVID-19 rapid diagnostic kit, and the results are shown in FIG. 11.

As a result of the experiment, it can be confirmed that the sensitivity of the sample concentrated using the sample concentration device of the present disclosure was improved compared to before concentration.

### Experimental Example 3

In the Example, 2 ml of a SARS-CoV-2 sample with a concentration of 2.3×10 copies/μL was collected and concentrated for 15 minutes. 50 μl of each sample before and after concentration was taken, and RNA was extracted therefrom using the Biofact DNA/RNA extraction kit and subjected to an experiment targeting the COVID-19 N gene using the real-time PCR (RT-PCR, BioRad CFX96™) method. The results are shown in FIG. 12.

As a result of the experiment, it was experimentally confirmed that, when the sample was concentrated using the sample concentration device of the present disclosure, the concentration speed could be significantly increased compared to that in the Comparative Example, suggesting that the user can concentrate the sample within a short time and perform the next stage of the experiment.

Therefore, the sample concentration device of the present disclosure may be conveniently used on site without a separate additional device or facility such as a centrifuge, and at the same time, can increase the target concentration in the sample and may be used directly in an in vitro diagnostic kit, thereby increasing the diagnostic sensitivity easily and effectively.

What is claimed is:

1. A sample concentration device comprising a sample chamber and an osmotic pressure-inducing fluid chamber,
wherein the osmotic pressure-inducing fluid chamber comprises a column portion and a pressure control portion,
wherein the column portion is inserted into the sample chamber, and the column portion comprises a membrane support and a membrane,
wherein the membrane is positioned between the membrane support and the sample chamber.

2. The sample concentration device of claim 1, wherein the membrane is in contact with an outer surface of the membrane support and is not in contact with the sample chamber.

3. The sample concentration device of claim 1, wherein the membrane is a semi-permeable membrane.

4. The sample concentration device of claim 1, wherein the pressure control portion comprises a sealing stopper and is coupled to an upper portion of the column portion.

5. The sample concentration device of claim 4, wherein the pressure control portion comprises a hollow portion therein and is open at the bottom.

6. The sample concentration device of claim 4, wherein the pressure control portion is configured to apply a positive pressure of 101% to 150% to the osmotic pressure-inducing fluid chamber when coupled to the upper portion of the column portion.

7. The sample concentration device of claim 1, wherein the osmotic pressure-inducing fluid chamber is configured such that an osmotic pressure-inducing solution is introduced into the column portion, wherein the osmotic pressure-inducing solution comprises one or two or more selected from the group consisting of polyethylene glycol, dextran, polyvinylpyrrolidone, hydroxyethylcellulose, and carboxymethyl cellulose.

8. The sample concentration device of claim 1, wherein the sample chamber comprises a sample inlet, a sample moving portion, and a sample discharge portion.

9. A sample concentration method for concentrating a sample using the sample concentration device of claim 1.

10. The sample concentration method of claim 9, comprising steps of:
introducing an osmotic pressure-inducing solution into a column portion of an osmotic pressure-inducing fluid chamber;
introducing a sample into a sample inlet of a sample chamber;
coupling a pressure control portion to the upper portion of the column portion of the osmotic pressure-inducing fluid chamber;
allowing the introduced sample to be concentrated while passing through a sample moving portion;
separating the osmotic pressure-inducing fluid chamber after the concentrated sample is collected at the bottom of the sample chamber; and
allowing the concentrated sample collected at the bottom of the sample chamber to move to a sample discharge portion.
